(19) United States
(12) Patent Application Publication
(10) Pub. No.: US 2026/0288262 A1
(43) Pub. Date: Sep. 24, 2026

(54) TOUCHPAD MODULE

(71) Applicant: Primax Electronics Ltd., Taipei (TW)

(72) Inventors: Wei-Chiang Huang, Taipei (TW); Wei-Ping Chan, Taipei (TW); Tse-Ping Kuan, Taipei (TW); Ming-Hui Yeh, Taipei (TW)

(21) Appl. No.: 19/374,531

(22) Filed: Oct. 30, 2025

(30) Foreign Application Priority Data
Mar. 21, 2025 (TW) 114110773

(51) Int. Cl. G06F 3/0354

(52) U.S. Cl. CPC G06F 3/03547

(57) ABSTRACT

A touchpad module includes a support member, a printed circuit board assembly (PCBA), and an elastic member. The support member has a plurality of strip-shaped gaps to define a resilient arm, in which the strip-shaped gaps form a symmetrical pattern, and the resilient arm has a central portion and a plurality of extension portions connected to the central portion. The printed circuit board assembly is located above the support member and includes a displacement sensing element, in which the displacement sensing element is adjacent to the resilient arm and faces the support member. The elastic member is disposed between the printed circuit board assembly and the central portion of the resilient arm of the support member.

### FIELD OF THE INVENTION

The present disclosure relates to a touchpad module, and more particularly to a touchpad module having a displacement sensing element.

### BACKGROUND OF THE INVENTION

Some electronic devices currently available on the market are equipped with a touchpad module. A user can slide the finger on the touchpad module to move the cursor on the screen of the electronic device, or press the touchpad module to cause the electronic device to execute a specific function. This eliminates the need for the user to carry and install an external mouse.

Generally, a support member of the touchpad module usually has a resilient arm defined by a single U-shaped gap, and a sensing element for sensing the deformation of the resilient arm is disposed on the resilient arm. When the touchpad module is pressed, the resilient arm deforms, and the sensing element for sensing the deformation of the resilient arm can detect a signal.

### SUMMARY OF THE INVENTION

The present disclosure provides a touchpad module, which includes a support member, a printed circuit board assembly (PCBA), and an elastic member. The support member has a plurality of strip-shaped gaps to define a resilient arm, in which the strip-shaped gaps form a symmetrical pattern, and the resilient arm has a central portion and a plurality of extension portions connected to the central portion. The printed circuit board assembly is located above the support member and includes a displacement sensing element, in which the displacement sensing element is adjacent to the resilient arm and faces the support member. The elastic member is disposed between the printed circuit board assembly and the central portion of the resilient arm of the support member.

In some embodiments of the present disclosure, the strip-shaped gaps at least partially surround each other, and the extension portions at least partially surround the central portion.

In some embodiments of the present disclosure, an area of the displacement sensing element is greater than or equal to an area of the central portion of the resilient arm.

In some embodiments of the present disclosure, the support member has two of the strip-shaped gaps to define the resilient arm.

In some embodiments of the present disclosure, the support member has three or four of the strip-shaped gaps to define the resilient arm.

In some embodiments of the present disclosure, the displacement sensing element is a capacitive sensing element.

In some embodiments of the present disclosure, the displacement sensing element is an inductive sensing element.

In some embodiments of the present disclosure, the touchpad module does not include a sensing element for sensing deformation of the resilient arm.

In some embodiments of the present disclosure, the touchpad module does not include a strain gauge.

In some embodiments of the present disclosure, the touchpad module does not include a piezoelectric sensing element.

### BRIEF DESCRIPTION OF THE DRAWINGS

Aspects of the present disclosure are best understood from the following embodiments, read in conjunction with accompanying drawings. However, it should be understood that in accordance with common practice in the industry, various features have not necessarily been drawn to scale. Indeed, shapes of the various features may be suitably adjusted for clarity, and dimensions of the various features may be arbitrarily increased or decreased.

FIG. 1 is a schematic external view of a touchpad module according to an embodiment of the present disclosure.

FIG. 2 is a schematic top perspective view of a touchpad module according to an embodiment of the present disclosure.

FIG. 3 is a schematic bottom perspective view of a touchpad module according to an embodiment of the present disclosure.

FIG. 4 is a schematic partial cross-sectional view of a touchpad module according to an embodiment of the present disclosure.

FIGS. 5A to 5D are schematic top views of resilient arms according to some embodiments of the present disclosure.

### DETAILED DESCRIPTION OF THE PREFERRED EMBODIMENT

The advantages and features of the present disclosure and the method for achieving the same will be described in more detail with reference to exemplary embodiments and accompanying drawings to make it easier to understand. However, the present disclosure can be implemented in different forms and should not be construed as being limited to the embodiments set forth herein. On the contrary, for those skilled in the art, the provided embodiments will make this disclosure more thorough, comprehensive and complete to convey the scope of the present disclosure.

The spatially relative terms in the text, such as “beneath” and “over”, are used to facilitate the description of the relative relationship between one element or feature and another element or feature in the drawings. The true meaning of the spatially relative terms includes other orientations. For example, when the drawing is flipped up and down by 180°, the relationship between the one element and the other element may change from “beneath” to “over.” The spatially relative descriptions used herein should be interpreted the same.

As mentioned in the prior art, generally, the support member of the touchpad module usually has the resilient arm defined by the single U-shaped gap, and the sensing element for sensing the deformation of the resilient arm is disposed on the resilient arm. When the touchpad module is pressed, the resilient arm deforms, and the sensing element for sensing the deformation of the resilient arm can detect the signal. However, the sensing elements currently commonly used for sensing the deformation of the resilient arm (e.g., a strain gauge or a piezoelectric sensing element) are relatively high in cost. The inventors have found that if another sensing element, such as a displacement sensing element, is used to replace the sensing element for sensing the deformation of the resilient arm, due to the resilient arm defined by the single U-shaped gap having only a single fulcrum, when the touchpad module is pressed, the resilient arm tilts and deforms downward from this single fulcrum. This behavior affects the sensing performance of the displacement sensing element, resulting in poor displacement sensing accuracy. Accordingly, the present disclosure provides a touchpad module, which includes a support member, a printed circuit board assembly (PCBA) having a displacement sensing element, and an elastic member, in which the support member has a plurality of strip-shaped gaps to define a resilient arm. The strip-shaped gaps form a symmetrical pattern, and the resilient arm has a central portion and a plurality of extension portions connected to the central portion. In other words, the resilient arm has a plurality of fulcrums (which are between the central portion and the extension portions). As a result, when the touchpad module is pressed, the resilient arm can deform downward in an approximately symmetrical manner, which is beneficial for the displacement sensing element to accurately sense the amount of displacement (i.e., the change in the distance between the printed circuit board assembly and the support member when the touchpad module is not pressed and after it is pressed), enabling the touchpad module to have better displacement sensing accuracy. Various embodiments of the touchpad module of the present disclosure will be detailed below.

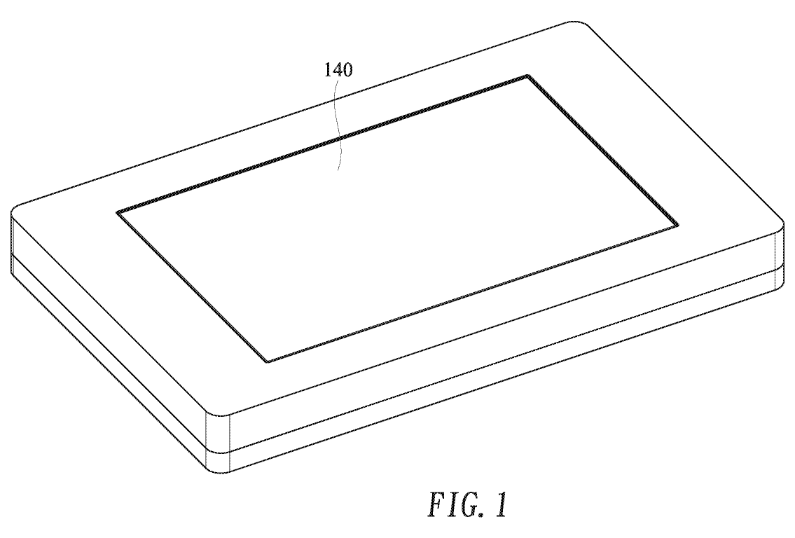

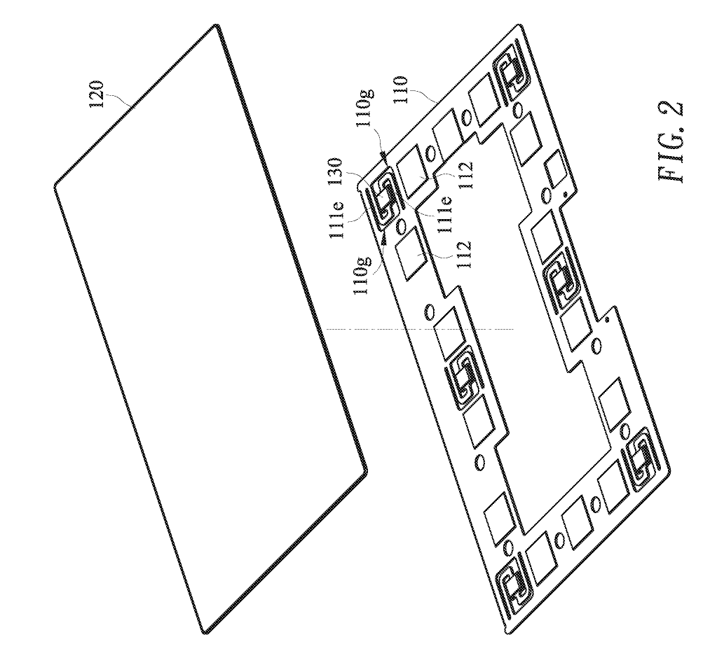

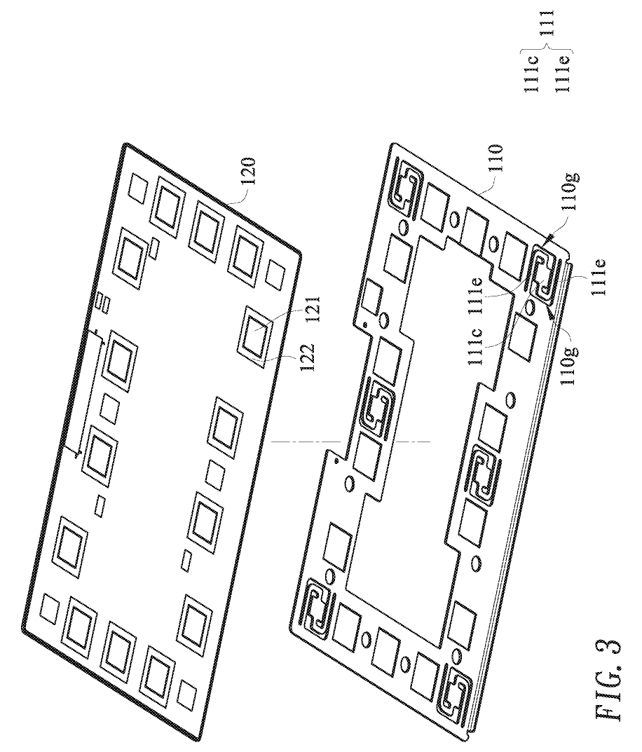

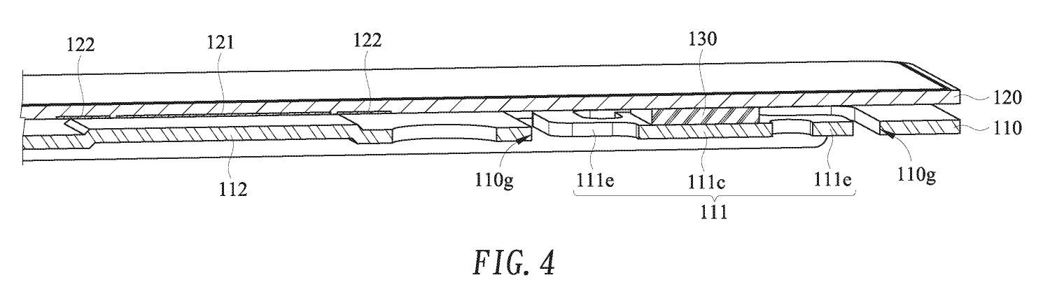

FIG. 1 is a schematic external view of a touchpad module according to an embodiment of the present disclosure. FIG. 2 is a schematic top perspective view of a touchpad module according to an embodiment of the present disclosure. FIG. 3 is a schematic bottom perspective view of a touchpad module according to an embodiment of the present disclosure. FIG. 4 is a schematic partial cross-sectional view of a touchpad module according to an embodiment of the present disclosure. As shown in FIGS. 1 to 4, the touchpad module includes a support member 110, a printed circuit board assembly (PCBA) 120, and an elastic member 130.

As shown in FIGS. 2 to 4, the support member 110 has a plurality of strip-shaped gaps 110g to define a resilient arm 111. The strip-shaped gaps 110g form a symmetrical pattern. In this context, the term "symmetrical" includes completely symmetrical and approximately symmetrical, which means that a pattern that, after undergoing a certain operation (e.g., reflection, rotation, etc.), completely or substantially coincides with the original pattern.

As shown in FIGS. 2 and 3, the support member 110 has two strip-shaped gaps 110g to define the resilient arm 111, so the resilient arm 111 has two fulcrums. The strip-shaped gaps 110g form a rotationally symmetrical pattern. The term "rotationally symmetrical" means that a pattern that, after being rotated by a certain angle, completely or substantially coincides with the original pattern.

As shown in FIGS. 2 to 4, the resilient arm 111 has a central portion 111c and a plurality of extension portions 111e, and the extension portions 111e are connected to the central portion 111c. The extension portions 111e are separated from each other. In some embodiments, the strip-shaped gaps 110g at least partially surround each other, and the extension portions 111e at least partially surround the central portion 111c.

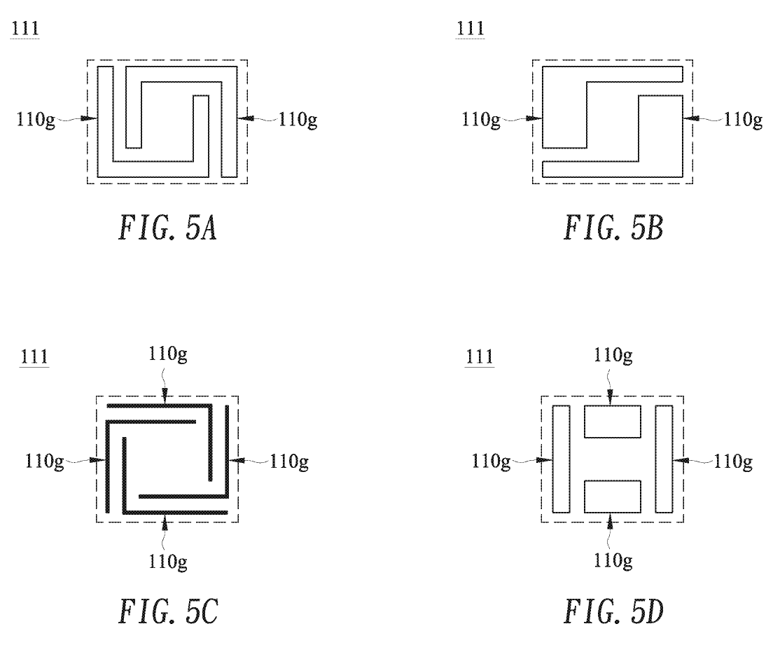

FIGS. 5A to 5D are schematic top views of resilient arms according to some embodiments of the present disclosure. In some embodiments, as shown in FIGS. 5A to 5D, the strip-shaped gaps 110g form a symmetrical pattern. In some embodiments, as shown in FIGS. 5A and 5B, the support member 110 has two strip-shaped gaps 110g to define the resilient arm 111, so the resilient arm 111 has two fulcrums. In some embodiments, as shown in FIGS. 5C and 5D, the support member 110 has four strip-shaped gaps 110g to define the resilient arm 111, so the resilient arm 111 has four fulcrums. However, the present disclosure is not limited to the foregoing embodiments. In other embodiments, the support member may have three or five or more strip-shaped gaps to define the resilient arm; in other words, the resilient arm may have three or five or more fulcrums. Furthermore, the strip-shaped gap 110g may have different or the same width at different positions. The strip-shaped gaps 110g may have the same or different shapes.

In some embodiments, as shown in FIGS. 2 and 4, the support member 110 has a convex portion 112 adjacent to the resilient arm 111. In some embodiments, the convex portion 112 is made by a stamping process or another suitable process.

As shown in FIGS. 2 to 4, the printed circuit board assembly 120 is located above the support member 110 and includes a displacement sensing element 121, which is used to detect the amount of displacement generated when the touchpad module is pressed, and convert it into an electronic signal for subsequent processing. As shown in FIG. 4, the displacement sensing element 121 is adjacent to the resilient arm 111 and faces the support member 110. In some embodiments, the displacement sensing element 121 faces the convex portion 112 of the support member 110.

It should be noted that, since the resilient arm 111 of the present disclosure has the fulcrums, when the touchpad module is pressed, the resilient arm 111 can deform downward in the approximately symmetrical manner, which is beneficial for the displacement sensing element 121 to accurately sense the amount of displacement (i.e., the change in the distance between the printed circuit board assembly 120 and the support member 110 when the touchpad module is not pressed and after it is pressed). Therefore, the touchpad module of the present disclosure has better displacement sensing accuracy.

On the other hand, since the printed circuit board assembly 120 of the touchpad module of the present disclosure includes the displacement sensing element 121, the touchpad module may not include a sensing element for sensing the deformation of the resilient arm 111; the touchpad module may not include a strain gauge; and/or the touchpad module may not include a piezoelectric sensing element. Therefore, compared with a touchpad module including a strain gauge or a piezoelectric sensing element, the cost of the touchpad module of the present disclosure is lower.

In some embodiments, the displacement sensing element 121 is a capacitive sensing element, an inductive sensing element, or other sensing elements that can be used to detect displacement. In some embodiments, the displacement sensing element 121 is a sensing electrode for capacitive sensing. In some embodiments, the printed circuit board assembly 120 further includes an active shield layer 122, which is adjacent to the displacement sensing element 121 to reduce external signal interference and improve the displacement sensing accuracy of the displacement sensing element 121. In some embodiments, as shown in FIG. 3, the active shield layer 122 surrounds the displacement sensing element 121. However, the present disclosure is not limited to the foregoing embodiments; in other embodiments, the active shield layer may be disposed at other positions.

In some embodiments, as shown in FIG. 3, an area of the displacement sensing element 121 is greater than or equal to an area of the central portion 111c of the resilient arm 111. In some embodiments, a number of the displacement sensing elements 121 is greater than a number of the resilient arms 111. It should be noted that the present disclosure is not limited to the foregoing embodiments, and in practical applications, the shape, area, disposition position, and number of the resilient arm and the displacement sensing element can be appropriately adjusted according to actual needs.

The elastic member 130 is disposed between the printed circuit board assembly 120 and the central portion 111c of the resilient arm 111 of the support member 110. In some embodiments, a length and a width of the elastic member 130 are respectively less than or equal to a length and a width of the central portion 111c of the resilient arm 111.

In some embodiments, as shown in FIG. 1, the touchpad module further includes a cover plate 140, which covers the printed circuit board assembly 120 shown in FIGS. 2 to 4 to protect the printed circuit board assembly 120. In some embodiments, the cover plate 140 is made of glass or other suitable material.

However, the above are only the preferred embodiments of the present disclosure, and should not be used to limit the scope of implementation of the present disclosure, that is, simple equivalent changes and modifications made in accordance with claims and description of the present disclosure are still within the scope of the present disclosure. In addition, any embodiment of the present disclosure or claim does not need to achieve all the objectives or advantages disclosed in the present disclosure. In addition, the abstract and the title are not intended to limit the scope of claims of the present disclosure.

What is claimed is:

1. A touchpad module, comprising:
a support member, having a plurality of strip-shaped gaps to define a resilient arm, wherein the strip-shaped gaps form a symmetrical pattern, the resilient arm having a central portion and a plurality of extension portions connected to the central portion;
a printed circuit board assembly (PCBA), located above the support member and including a displacement sensing element, wherein the displacement sensing element is adjacent to the resilient arm and faces the support member; and
an elastic member, disposed between the printed circuit board assembly and the central portion of the resilient arm of the support member.

2. The touchpad module of claim 1, wherein the strip-shaped gaps at least partially surround each other, and the extension portions at least partially surround the central portion.

3. The touchpad module of claim 1, wherein an area of the displacement sensing element is greater than or equal to an area of the central portion of the resilient arm.

4. The touchpad module of claim 1, wherein the support member has two of the strip-shaped gaps to define the resilient arm.

5. The touchpad module of claim 1, wherein the support member has three or four of the strip-shaped gaps to define the resilient arm.

6. The touchpad module of claim 1, wherein the displacement sensing element is a capacitive sensing element.

7. The touchpad module of claim 1, wherein the displacement sensing element is an inductive sensing element.

8. The touchpad module of claim 1, wherein the touchpad module does not include a sensing element for sensing deformation of the resilient arm.

9. The touchpad module of claim 1, wherein the touchpad module does not include a strain gauge.

10. The touchpad module of claim 1, wherein the touchpad module does not include a piezoelectric sensing element.
